(19) United States
(12) Patent Application Publication
(10) Pub. No.: US 2024/0269636 A1
(43) Pub. Date: Aug. 15, 2024

(54) ULTRA-HIGH THROUGHPUT ON-CHIP SYNTHESIS OF MICROGELS WITH TUNABLE MECHANICAL PROPERTIES

(71) Applicant: THE TRUSTEES OF THE UNIVERSITY OF PENNSYLVANIA, Philadelphia, PA (US)

(72) Inventors: Daeyeon LEE, Wynnewood, PA (US); David Aaron ISSADORE, Philadelphia, PA (US); Jingyu WU, Philadelphia, PA (US); Sagar Prasad YADAVALI, Downington, PA (US)

(21) Appl. No.: 18/569,403

(22) PCT Filed: Jun. 14, 2022
(86) PCT No.: PCT/US2022/072939

§ 371 Date: Dec. 12, 2023

Related U.S. Application Data
(60) Provisional application No. 63/210,149, filed on Jun. 14, 2021.

(51) Int. Cl. B01J 13/00; B01J 19/00; C08F 2/48

(52) U.S. Cl. CPC B01J 13/0052; B01J 19/0093; C08F 2/48; B01J 2219/00792; B01J 2219/00936

(57) ABSTRACT

Hydrogel particles (microgels) generated using microfluidic methods have superb properties such as high size uniformity and precise control over degradation and release profiles, making them useful for applications in wound healing and injectable drug delivery. However, the throughput of microfluidics is constrained by the physics governing the flow of immiscible fluids confined within microchannels. This throughput tends to be several orders of magnitude lower than what would be necessary for commercial and clinical applications. Here, we demonstrate the scaling up of on-chip synthesis of microgels by parallelizing the microfluidic channels. Taking advantage of the established fabrication technologies developed by the semiconductor industry and a high flow control system, a 4-inch silicon microfluidic chip integrating more than 4,000 microfluidic devices is developed. By incorporating a high energy flood UV source, this chip allows the synthesis of poly (ethylene glycol) diacrylate microgel particles with diameter down to 30 m at a throughput above Ikg/hr. By using photomasks that enable milli-second scale control of the UV exposure, the stiffness of microgels can be varied.

### CROSS REFERENCE TO RELATED APPLICATIONS

The present application claims priority to and the benefit of U.S. patent application No. 63/210,149, “Ultra-High Throughput On-Chip Synthesis Of Microgels With Tunable Mechanical Properties” (filed Jun. 14, 2021), the entirety of which application is incorporated herein by reference for any and all purposes.

### GOVERNMENT RIGHTS

This invention was made with government support under Contract No. HG010023 awarded by the National Institutes of Health. The government has certain rights in the invention.

### TECHNICAL FIELD

The present disclosure relates to the field of microfluidics and to the field of hydrogel formation.

### BACKGROUND

Uniform micron-sized hydrogel particles, or microgels, have proven to have unique properties for wide biomedical applications, compared to bulk hydrogels. Microgels are used as carriers for drug or cell deliveries, templates for tissue engineering constructs, and 3D microenvironments for cell cultures, owing to their small size, high modularity and high water content.

Ensuring uniform physiochemical properties among the microgels is crucial for building extracellular matrix (ECM) since they control the porosity, packing density, and injectability of the scaffold, which dictates the cellular interaction and outcomes. Mechanical properties of microenvironment greatly influence the cell behaviors; different stiffness of the matrix can direct cell lineage specification, spreading, and proliferation.

Existing methods for forming microgels, however, suffer from slow output and other inefficiencies. Accordingly, there is a long-felt need in the field for improved systems and methods for microgel formation.

### SUMMARY

In meeting the described long-felt needs, the present disclosure first provides microgel generators, comprising: a continuous phase fluid inlet for receiving a continuous phase fluid; a dispersed phase fluid inlet for receiving a dispersed phase fluid; a plurality of exposure lanes, the plurality of exposure lanes in fluid communication with the continuous phase inlet and the dispersed phase inlet; a plurality of flow focusing generators, a flow focusing generator defining a microdroplet outlet through which discrete portions of the dispersed phase fluid are exerted, an exposure lane being in fluid communication with the microdroplet outlet of a flow focusing generator associated with that exposure lane; and a radiation source, the radiation source configured to illuminate at least a portion of the exposure lanes so as to effect curing of polymer comprised in microdroplets disposed in the exposure lanes.

Also provided are methods, the methods comprising operating a microgel generator according to the present disclosure (e.g., any one of Aspects 1-9) so as to form microgel particles.

Further provided are methods, the methods, comprising: flowing a dispersed phase fluid comprising a polymerizable material and a continuous phase fluid such so as to give rise to discrete droplets of the dispersed phase fluid disposed within the continuous phase fluid, the discrete droplets disposed in a section of a microfluidic chip; and curing the discrete droplets while the discrete droplet is within the microfluidic chip so as to form microgel particles, the curing being accomplished by radiation exposure.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various aspects discussed in the present document. In the drawings:

FIGS. 1A-1E provide an overview of the parallelized chip for high throughput on-chip polymerization. (FIG. 1A) Schematic representation of UV polymerization of parallel microgel generators. (FIG. 1B) Microscopic image of parallel generation of pre-polymer droplets. (FIG. 1C) Schematic representation of the cross section of the silicon-glass chip. (FIG. 1D) Exemplary chip. (FIG. 1E) Microgels produced in 10 mins collected in a bottle. Insets: (i) Fluorescent image of the microgels (ii) SEM image of the microgels.

FIGS. 2A-2D provide a polymerization time scale characterization using single-channel device (FIG. 2A) Schematic representation of UV polymerization in PDMS device (FIG. 2B) Microscopic image of single channel polymer droplet formation (FIG. 2C) Mechanism of photo polymerization of PEGDa with LAP (FIG. 2D) Plot showing exposure time and dispersed flow rate effect on gelation (i) Microscopic image of exposed polymer droplet with sufficient UV energy (ii) and exposed polymer droplet with insufficient UV energy.

FIGS. 3A-3E provide a scaled-up generation of microgels. (FIG. 3A) Droplet generation in a parallelized chip with 4080 identical devices. (FIG. 3B) Microscopic image of on-chip cured microgels. (FIG. 3C, 3E) Histograms of gel size distribution of microgels cured from on-chip and off-chip, respectively. Green represent off-chip and Blue represents on-chip (FIG. 3D) Microscopic image of off-chip cured microgels.

FIGS. 4A-4C provide mechanical testing of the microgels using capillary micromechanics. (FIG. 4B) Compression and shear modulus of gels with controlled exposure times (FIG. 4C) Swelling ratio of microgel samples with different exposure time (FIG. 4A) Microscopic images of measurement of gel by gradually increasing hydrostatic pressure in a glass capillary.

FIG. 5 provides an illustration of scale-up synthesis of spherical microgels, showing droplet generation in 4080 devices, at a throughput of about 1.1 kg/hr.

FIG. 6 illustrates that microgels subject to a comparatively higher UV dosage can show a smaller swelling ratio. FIG. 6 also provides fluorescent images of example microgel samples for swelling characterization (i) Microgels swollen in PBS, and (ii) Dried microgel particles.

FIG. 7 provides example microgel stiffness, measured by capillary micromechanics, and as a function of microgel exposure time.

FIG. 8 provides example microgel modulus as a function of microgel exposure time.

FIG. 9 illustrates example rod-shaped and raft-shaped microgels formed by the disclosed technology.

FIG. 10 provides an illustration of certain microgel shapes that can be achieved by the disclosed technology, e.g., by varying flow rates.

FIG. 11 illustrates that on-chip gelation enables continuous synthesis of anisotropic particles, illustrating raft-shaped and rod-shaped microgels.

FIG. 12 illustrates differently-shaped particles formed by using parallelized devices according to the present disclosure.

FIG. 13 provides an example, non-limiting clamped system that can replace an epoxy system of an inlet/outlet and the addition of a liquid reservoir.

FIG. 14 provides example droplet diameter plotted against different dispersed flow rates. The flow ratio between continuous phase and dispersed phase is kept the same at 3 for all conditions.

FIG. 15 provides an example device that uses a metal clamp as chip and photomask holder. Images showing (i) the top and bottom metal pieces. (ii) Chip and photomask placed on top of the bottom piece. (iii) Top view of the assembly of the clamp system. (iv) bottom view of the assembly, where bronze metal fittings are used for fluidic connections.

FIG. 16 provides example stress versus strain plots for modulus measurements of microgels under 4 exposure times. (i) Compressive stress versus volumetric strain. The slopes give the compressive modulus of the microgels. (ii) Differential stress versus its characteristic strain. The slopes give the shear modulus of the microgels.

FIG. 17 provides examples of microscopic images of microgels under (i) swollen state and (ii) dried state to characterize swelling ratio. Both scale bars are 50 μm.

FIG. 18 provides a cross-section of a device according to the present disclosure.

### DETAILED DESCRIPTION OF ILLUSTRATIVE EMBODIMENTS

The present disclosure may be understood more readily by reference to the following detailed description of desired embodiments and the examples included therein.

Unless otherwise defined, all technical and scientific terms used herein have the same meaning as commonly understood by one of ordinary skill in the art. In case of conflict, the present document, including definitions, will control. Preferred methods and materials are described below, although methods and materials similar or equivalent to those described herein can be used in practice or testing. All publications, patent applications, patents and other references mentioned herein are incorporated by reference in their entirety. The materials, methods, and examples disclosed herein are illustrative only and not intended to be limiting.

The singular forms “a,” “an,” and “the” include plural referents unless the context clearly dictates otherwise.

As used in the specification and in the claims, the term “comprising” may include the embodiments “consisting of” and “consisting essentially of.” The terms “comprise(s),” “include(s),” “having,” “has,” “can,” “contain(s),” and variants thereof, as used herein, are intended to be open-ended transitional phrases, terms, or words that require the presence of the named ingredients/steps and permit the presence of other ingredients/steps. However, such description should be construed as also describing compositions or processes as “consisting of” and “consisting essentially of” the enumerated ingredients/steps, which allows the presence of only the named ingredients/steps, along with any impurities that might result therefrom, and excludes other ingredients/steps.

As used herein, the terms “about” and “at or about” mean that the amount or value in question can be the value designated some other value approximately or about the same. It is generally understood, as used herein, that it is the nominal value indicated ±10% variation unless otherwise indicated or inferred. The term is intended to convey that similar values promote equivalent results or effects recited in the claims. That is, it is understood that amounts, sizes, formulations, parameters, and other quantities and characteristics are not and need not be exact, but can be approximate and/or larger or smaller, as desired, reflecting tolerances, conversion factors, rounding off, measurement error and the like, and other factors known to those of skill in the art. In general, an amount, size, formulation, parameter or other quantity or characteristic is “about” or “approximate” whether or not expressly stated to be such. It is understood that where “about” is used before a quantitative value, the parameter also includes the specific quantitative value itself, unless specifically stated otherwise.

Unless indicated to the contrary, the numerical values should be understood to include numerical values which are the same when reduced to the same number of significant figures and numerical values which differ from the stated value by less than the experimental error of conventional measurement technique of the type described in the present application to determine the value.

All ranges disclosed herein are inclusive of the recited endpoint and independently of the endpoints (e.g., “between 2 grams and 10 grams, and all the intermediate values includes 2 grams, 10 grams, and all intermediate values”). The endpoints of the ranges and any values disclosed herein are not limited to the precise range or value; they are sufficiently imprecise to include values approximating these ranges and/or values. All ranges are combinable.

As used herein, approximating language may be applied to modify any quantitative representation that may vary without resulting in a change in the basic function to which it is related. Accordingly, a value modified by a term or terms, such as “about” and “substantially,” may not be limited to the precise value specified, in some cases. In at least some instances, the approximating language may correspond to the precision of an instrument for measuring the value. The modifier “about” should also be considered as disclosing the range defined by the absolute values of the two endpoints. For example, the expression “from about 2 to about 4” also discloses the range “from 2 to 4.” The term “about” may refer to plus or minus 10% of the indicated number. For example, “about 10%” may indicate a range of 9% to 11%, and “about 1” may mean from 0.9-1.1. Other meanings of “about” may be apparent from the context, such as rounding off, so, for example “about 1” may also mean from 0.5 to 1.4. Further, the term “comprising” should be understood as having its open-ended meaning of “including,” but the term also includes the closed meaning of the term “consisting.” For example, a composition that comprises components A and B may be a composition that includes A, B, and other components, but may also be a composition made of A and B only. Any documents cited herein are incorporated by reference in their entireties for any and all purposes.

Drop-microfluidic based synthesis of offers excellent control of microgel physiochemical properties with controlled size (5-100's of μm) and high uniformity (<5% CV). Moreover, multi-step processes can be integrated to modulate the particles' properties. However, the throughput of microfluidic device is limited in a single-channel device for realizing the above-motioned applications in a large-scale and for moving to clinical settings.

In the past decade, parallelization of microfluidic has achieved great progress on increasing the microfluidic emulsion generation to several liters per hour, shedding lights on high throughput synthesis of microgels. While throughput has greatly improved from single-channel device, the production rate remains at lab-scale and requires more improvement. Furthermore, existing approaches rely on off-chip solidification process, which limits the control during the gelation process, and requires careful selection of surfactants to prevent coalescence.

In contrast, on-chip solidification allows crosslinking reactions to start immediately after the pre-polymer droplets are formed, thus minimizing the contact between droplets, and improving uniformity. Additionally, on-chip solidification provides precise control of the UV dosage since each droplet experience the same exposure time, providing control of the degree of crosslinking, and hence the mechanical property of the particle. To date, few efforts have been made to increase the throughput of on-chip photopolymerization process. A further challenge to massively parallel photopolymerization units is to prevent light from exposing to unwanted areas and cause solidification pre-forming the droplets. From this perspective, commonly used PDMS is not a suitable material since light can penetrate and scatter in PDMS devices.

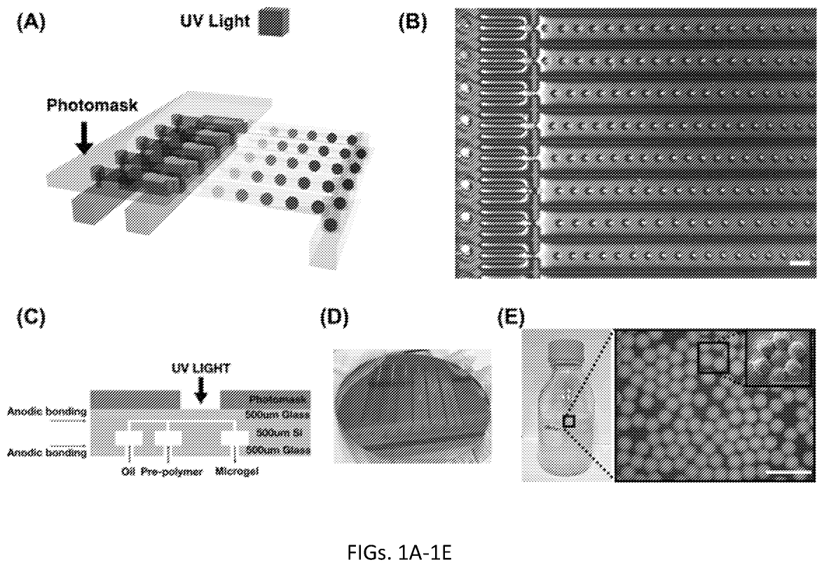

Here we report, inter alia, an ultra-high throughput synthesis of microgels by paralleling 4080 flow focusing channels on a single 4-inch chip (FIGS. 1A-1B). A silicon-based chip that is three-dimensionally patterned will be used to (1) endure the high pressure used for driving densely packed parallel fluidic channels, and (2) prevent flood UV source from transmitting or scattering to the regions pre-forming the droplets. The fabrication of the device can be accomplished using standard photolithography and dry etching technique (FIGS. 1C-1D). For illustrative purposes, we use a biocompatible polymer poly-(ethylene)-glycol diacrylate with a water-soluble photo initiator Lithium phenyl-2,4,6-trimethylbenzoylphosphinate (LAP) as a model system for photo polymerization. We achieved a production rate up to 1.1 kg/hr of PEGDa microgels with a microgel diameter below 40 μm. (FIG. 1E). Further, we explored tuning the mechanical properties of microgels by controlling the exposure time, and demonstrated that the stiffness of the particles can increase an order of magnitude higher with an increase of ˜250 ms exposure time. It should be understood, however, that the particular materials and products used to illustrate the disclosed technology are not limiting and are illustrative only, i.e., other polymers besides poly-(ethylene)-glycol diacrylate can be used.

### Results & Discussion

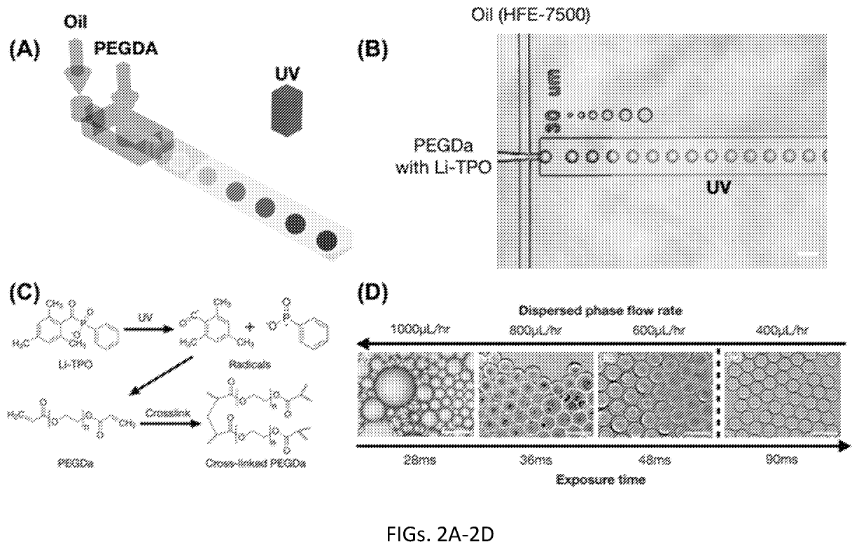

On-chip UV polymerization can be implemented by exposing UV light to the microfluidic channel downstream of the droplet generation device (FIGS. 2A-2B). To achieve adequate crosslinking of the pre-polymer droplets, sufficient UV dosage is required to carry out the reaction. A common approach is to design the UV exposure channel to be in excess length, such as using serpentine geometry, to ensure a prolonged exposure time for complete polymerization. However, such strategy compromises the number of devices per area when they are parallelized. Therefore, we first determine the gelation time scale of the polymer system to minimize the design footprint of each device.

Poly (ethylene glycol) diacrylate (PEGDa, Mn=575) is employed as hydrogel precursor and lithium-benzophenotriphosphate (LAP) as photoinitiator to trigger the chain polymerization when triggered by UV (FIG. 2C). The pre-polymer mixture is emulsified using a flow-focusing type microfluidic device (FFG), where the inner polymer PEGDa phase is pinched off by the outer oil phase, forming discrete uniform droplets. The oil phase is comprised of a commercially available perfluorinated oil, HFE-7500, and 2 wt % of surfactant, Krytox 157 FSH, as a droplet stabilizer.

Downstream of the droplet generation, a point UV source is used to expose light through the channel where droplets pass by, triggering the initiator to start reaction. To control the residence time of droplets under UV, the flow rates of the oil and pre-polymer phases are varied to control the velocity of droplet passing the UV region, while maintaining the UV intensity and exposure area the same.

By setting a constant flow rate ratio of the continuous flow over the dispersed phase, the droplet diameters under different flow rates are kept close. The collected gels are transferred into water following a serial purification with hexane, IPA and water to remove the organic solvents. The gel point is found at a critical exposure time t_{c}≅60 ms. Above the critical exposure time, the collected gels are able to hold their structural integrity and remain homogeneous after washing (FIG. 2D). Insufficient UV exposure time (t<60 ms) leads to partially crosslinked polymer droplet that contain portions of unpolymerized liquid, which coalesce in the collection bath (FIG. 2D).

The gelation time scale then guides the design of the parallelized chip to use the minimum exposure channel length. From the two previous proposed layouts for parallelized microfluidic chip, ladder geometry is chosen instead of the tree geometry since it allows a smaller footprint (area of the entire chip) and less sensitive to small perturbations from upstream affecting downstream. To ensure even flow throughout the devices in the chip, the design follows the previously established design rule,

$$2 N ( \frac{Rd}{Rdev} ) < 0.01 ,$$

where N is the total number of devices, R_{d} is the fluid resistance of the delivery channel, and R_{dev} that of the individual device. Flow resistors are incorporated upstream the droplet generators to allow the operation of higher volumetric flow rate before reaching the dripping-to-jetting transition, as previously demonstrated. Silicon and glass chip is used for two main advantages: (1) Robustness of the fabrication process provides uniform channel dimensions, and high bonding strength required for operating the device at a high pressure (>50 psi) due to the high resistance channels incorporated into the structure. Further, (2) silicon is opaque to UV, and therefore serves as a natural protective mask that prevents UV to polymerize the polymer phase in the distribution channels.

The three-dimensional silicon—and glass microfluidic chip was fabricated using a lithographic process similar to previously-reported methods in Yadavali et al., Nat Commun. 2018, 9, 1222, and in Yadavali et al., Sci Rep 2019, 9, 12213. Briefly, one side of the silicon wafer is etched for wide and deep channels for distributing the fluids across the through silicon vias (TSVs) to the parallel droplet generation channels, located on the other side of the wafer. The chip is then connected to a pressure-driven high throughput flow setup for droplet generation, with both inlet flows measured by two Coriolis flow meters. To polymerize the produced pre-polymer droplets from the parallel channels, the chip is housed by a flood UV source and covered by a chromium photomask, which protects the regions pre droplet formation to avoid unwanted polymerization. The photomask is brought to close physical contact with the chip using a clamp system that is composed of two aluminum metal pieces.

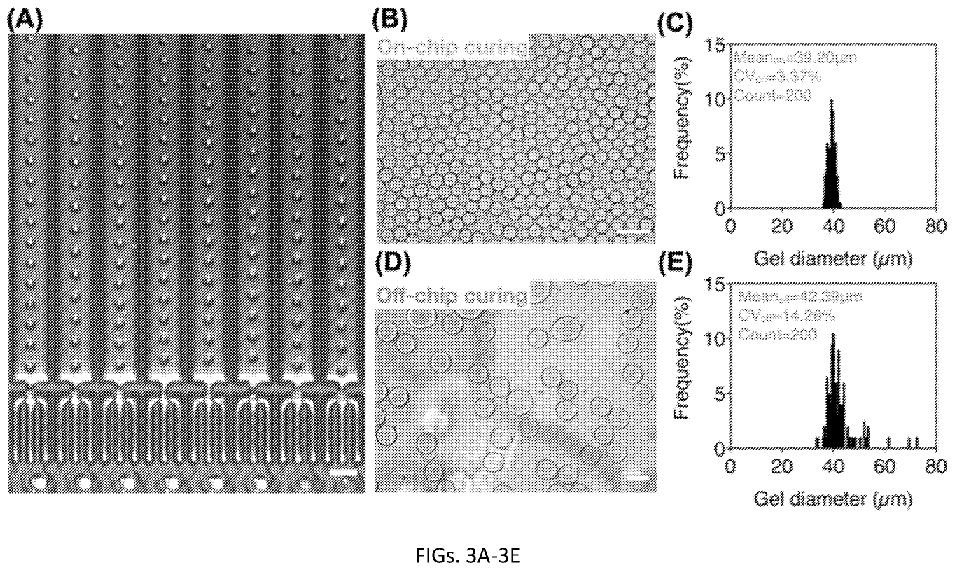

By setting the flow rate of the dispersed phase and continuous phase to be 1 L/hr and 3.2 L/hr, respectively, pre-polymer droplets are generated in a parallel fashion and flow in single rows, moving toward the downstream vias (FIG. 3A). The chip, along with the photomask and clamp, is transferred to the UV chamber once the flows are stabilized, and exposed to UV light with constant intensity, ˜180 mW/cm².

The solidified microgels are collected in a beaker, followed by a series washing steps repeatedly with hexane, 50/50 IPA/water, DI water, and PBS, with centrifugation in between each wash. The washing protocol removes the continuous phase and stores the gels in PBS for further analysis. FIG. 3B is a microscopic image of the cleaned microgels with an average diameter of ˜39.2 μm and a CV (coefficient of variation) of 3.37%. The histogram is shown in FIG. 3C. On-chip solidification allows the pre-polymer droplets to crosslink immediately after generation, avoiding droplets coalescence due to collisions and low surfactant stability. This allowed generation of microgels with higher uniformity than those produced off-chip. In comparison, the pre-polymer droplets are produced using the conditions, and off-chip curing is performed by exposing UV light directly to the collected droplets. The mean droplet size increased due to coalescence of the droplets, with a significantly larger CV of 14.26% (FIGS. 3D-3E).

By controlling the flow rates of both phases, the residence time of the droplets under UV light can be varied from 90 ms to above 360 ms. This aspect can be utilized to control the UV dosage given to the droplets, resulting in microgels with various crosslinking densities. To verify this, the microgels' stiffness and swelling ratio are measured, as they relate to the degree of crosslinking.

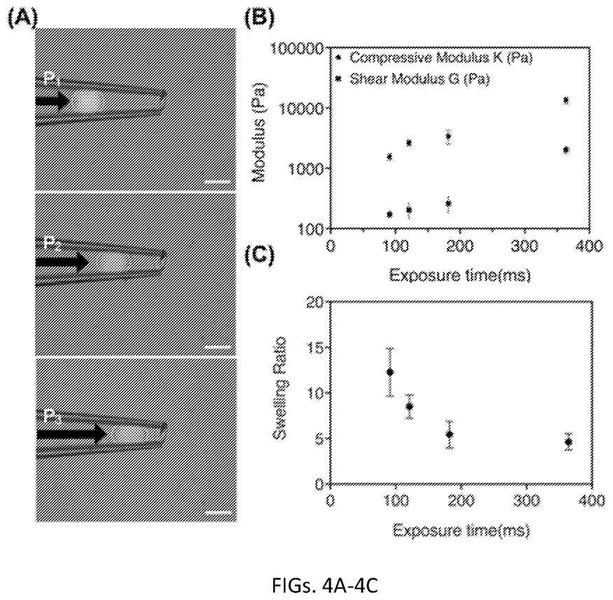

The stiffness of the microgels is measured using capillary micromechanics. Briefly, the microgel particle is flowed inside a tapered capillary, which has a tip diameter smaller than that of the microgel. As the pressure from the source increases, the pressure applied on the microgel pushes the microgel toward the tip with larger deformation (FIG. 4A). In the performed experiments, a hydrostatic source is used to provide pressure steps from p=200 Pa to p=1200 Pa. Mechanical properties of the particles are characterized based on the deformation, and the stress versus strain relationships. Compressive elastic modulus K, which characterizes the resistance of the material to volume change, and shear elastic modulus G, which characterizes the resistance of material to shape deformation, are found from the slopes of the stress versus strain plots, and FIG. 4B shows both modulus from gels with different exposure times, from 91 ms to 364 ms. Both modulus differ by an order of magnitude (10³˜10⁴ Pa for K, 10²˜10³ Pa for G) between the gels receiving the most UV energy and the least, showing that the UV dosage have a significant effect on the mechanical properties of the gels.

Swelling behavior is another key parameter that is directly linked to the degree of crosslinking of the microgel particles, as described by the Flory-Rehner theory. The volume swelling ratio of the microgels is determined by measuring the radius in swollen state, rₛ, and de-swollen state, r_{d}, to empirically achieve the swelling ratio Q=rₛ/r_{d}. FIG. 4C shows the swelling ratio of microgels with different exposure times from the same batches of the gels used for measurement in FIG. 4B. The swelling ratio of the gels decrease from 12.2 to 4.6 with increase in exposure time, which is in good agreement with the measurement of modulus that crosslink density can be tuned by controlling the given UV dosage. In all these experiments, the gels are swollen in DI water for overnight, and deswollen gels are dehydrated using lyophilizer.

TABLE 1
Comparison of microfluidic devices for photopolymer synthesis

| | | | | | | Volumetric |
|---|---|---|---|---|---|---|
| | | | Particle | | Number of | flow rate of |
| | Particle | Solidification | diameter | | droplet | dispersed phase |
| Reference | material | type | (μm) | CV (%) | generators | (ml/hr) |
| This work | PEG-DA | On-Chip | 39.2 | 3.37 | 4080 | 1020 |
| ^{[19]} | 8-arm PEG-VS | Off-Chip | 90 | 3~6 | 200 | 25.2 |
| ^{[5]} | PEG-4MAL | Off-Chip | 60~100 | 6.3~12.7 | 8 | 3 |
| ^{[37]} | NOA60 | On-Chip | >20 | — | 1 | 0.003 |

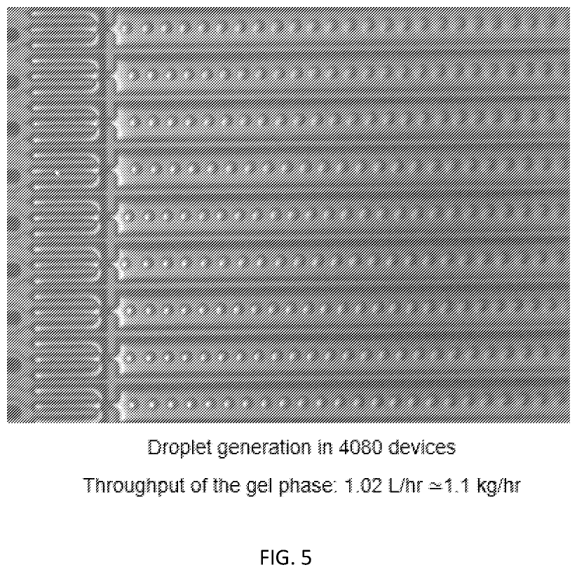

FIGS. 5-17 provide further illustrative, non-limiting disclosure.

FIG. 5 provides an illustration of scale-up synthesis of spherical microgels, showing droplet generation in 4080 devices, at a throughput of about 1.1 kg/hr. As shown, the disclosure technology enables one to achieve a comparatively high throughout of gels.

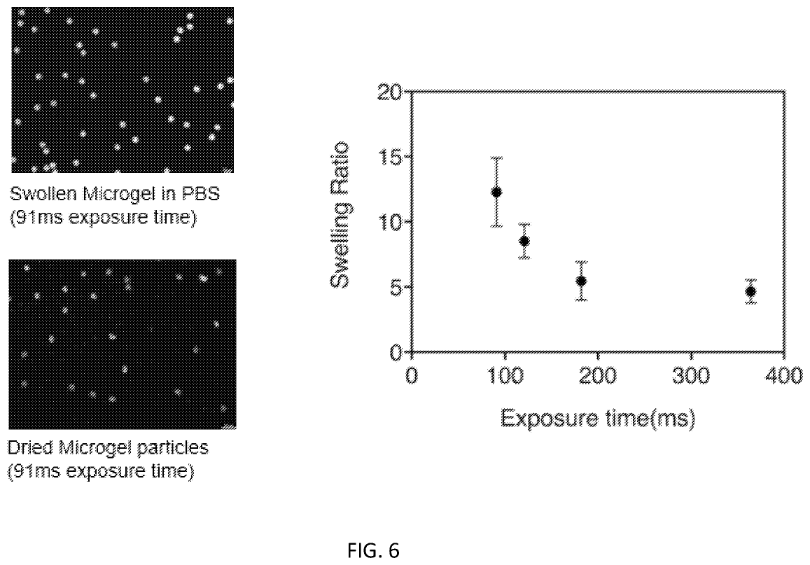

FIG. 6 illustrates that microgels subject to a comparatively higher UV dosage can show a smaller swelling ratio. This in turns enables the user to achieve the desired swelling ratio by modulating UV dosage.

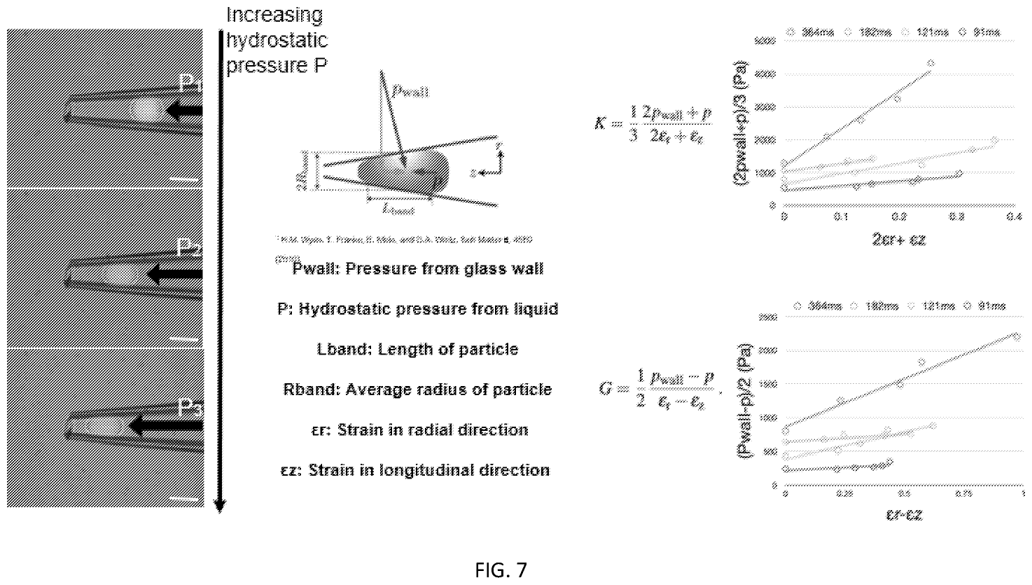

FIG. 7 provides example microgel stiffness, measured by capillary micromechanics, and as a function of microgel exposure time. As shown, the mechanical properties of a given gel can be modulated by the applied UV dosage.

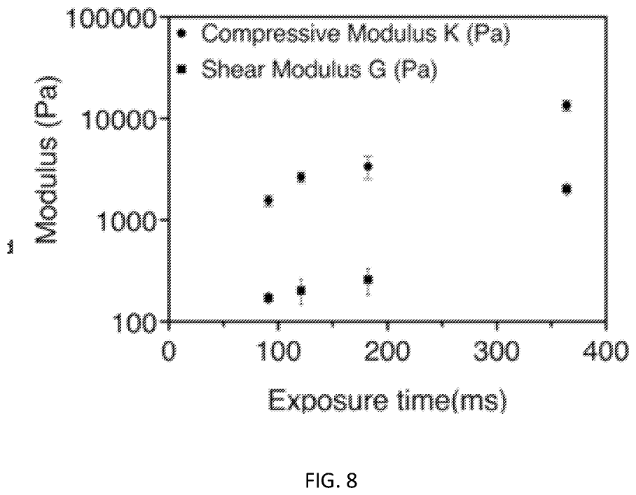

FIG. 8 provides example microgel modulus (compressive modulus K (Pa) and shear modulus G (Pa)) as a function of microgel exposure time.

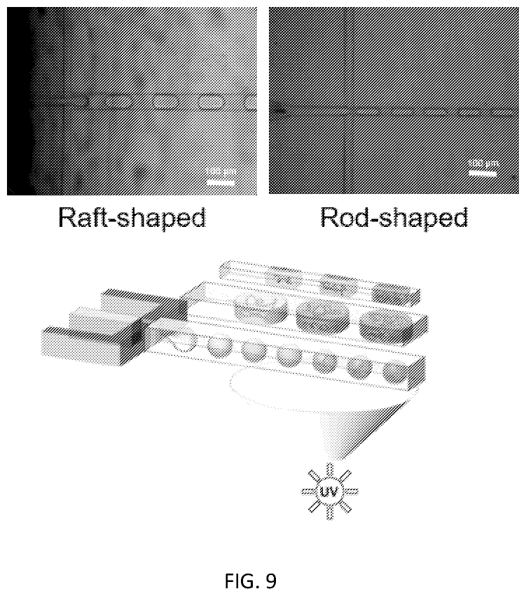

FIG. 9 illustrates example rod-shaped and raft-shaped microgels formed by the disclosed technology.

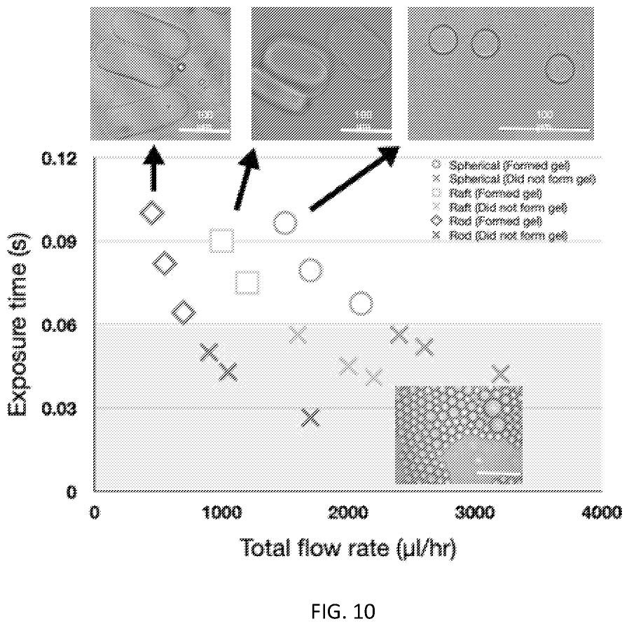

FIG. 10 provides an illustration of certain microgel shapes that can be achieved by the disclosed technology, e.g., by varying flow rates. As shown, modulating flow rate can allow the user to achieve spherical, rod-shaped, and/or raft-shaped particles.

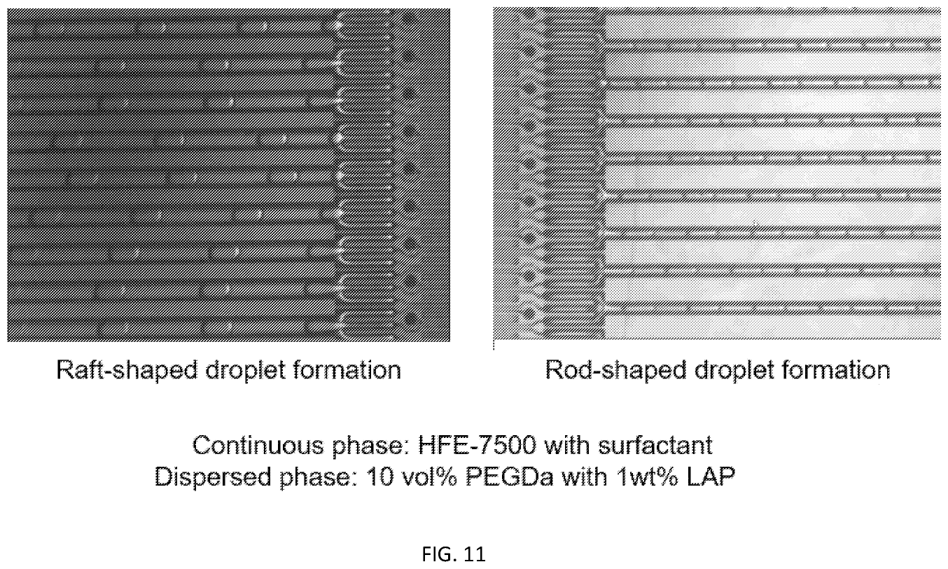

FIG. 11 illustrates that on-chip gelation enables continuous synthesis of anisotropic particles, illustrating raft-shaped and rod-shaped microgels

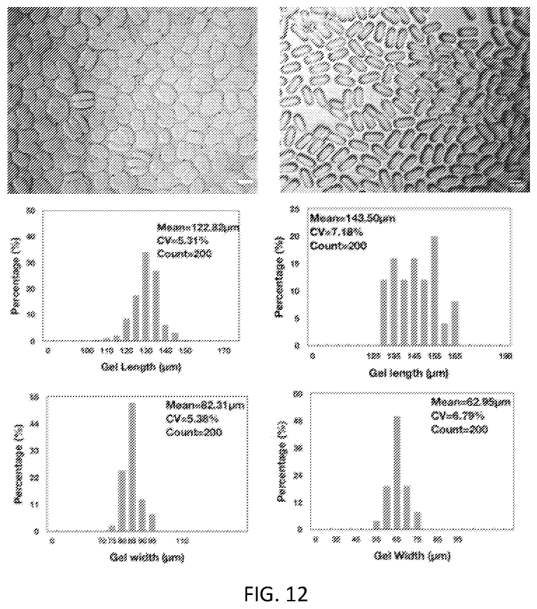

FIG. 12 illustrates differently-shaped particles formed by using parallelized devices according to the present disclosure.

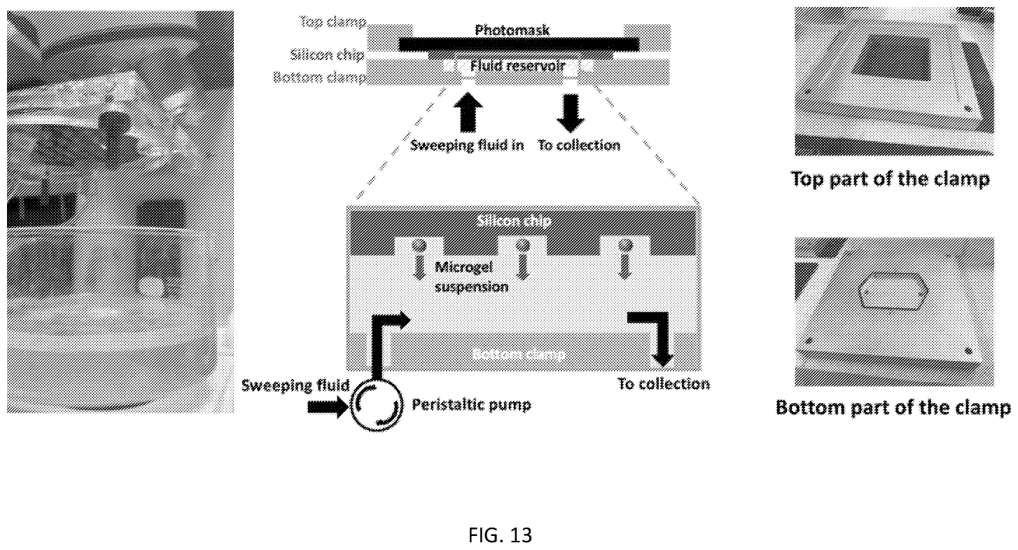

FIG. 13 provides an example, non-limiting claim system that can replace an epoxy system of an inlet/outlet and the addition of a liquid reservoir.

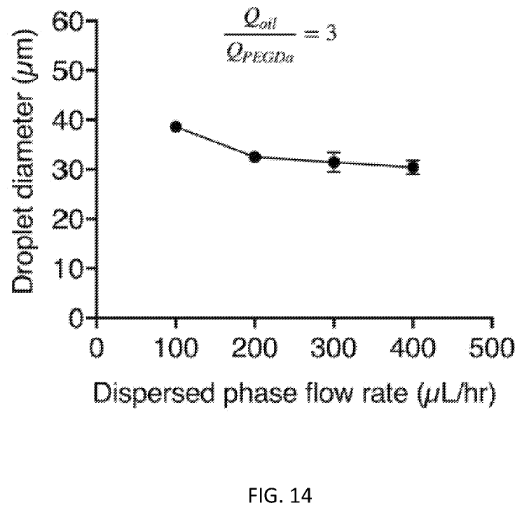

FIG. 14 provides example droplet diameter plotted against different dispersed flow rates. The flow ratio between continuous phase and dispersed phase is kept the same at 3 for all conditions.

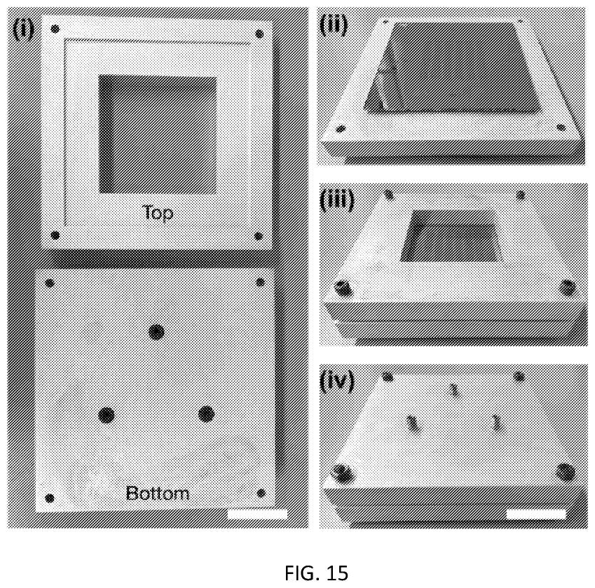

FIG. 15 provides an example device that uses a metal clamp as chip and photomask holder. Images showing (i) the top and bottom metal pieces. (ii) Chip and photomask placed on top of the bottom piece. (iii) Top view of the assembly of the clamp system. (iv) bottom view of the assembly, where bronze metal fittings are used for fluidic connections.

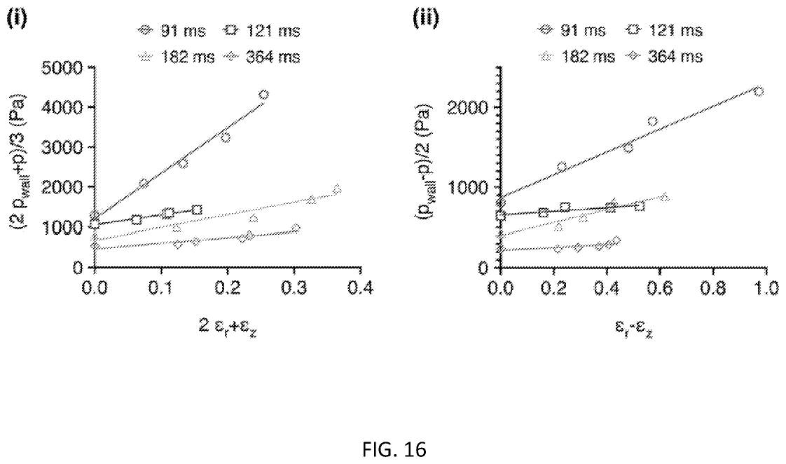

FIG. 16 provides example stress versus strain plots for modulus measurements of microgels under 4 exposure times. (i) Compressive stress versus volumetric strain. The slopes give the compressive modulus of the microgels. (ii) Differential stress versus its characteristic strain. The slopes give the shear modulus of the microgels.

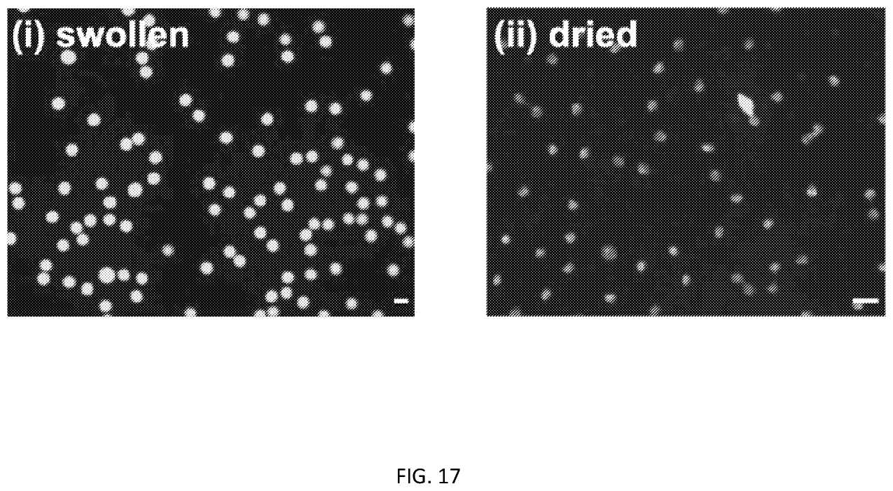

FIG. 17 provides examples of microscopic images of microgels under (i) swollen state and (ii) dried state to characterize swelling ratio. Both scale bars are 50 μm.

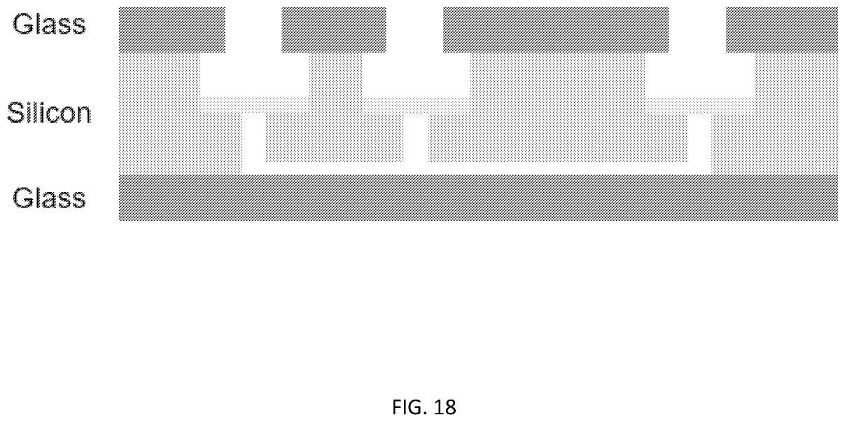

FIG. 18 provides a cross-section of a device according to the present disclosure.

### SUMMARY

We designed an in-situ photocuring microfluidic platform and demonstrated massive generation of anisometric microgel particles (e.g., spherical, raft-shaped, rod-shaped). Four thousand parallel droplet generators are integrated on a 4-inch silicon chip, allowing kilogram scale generation of microgel particles. The device architecture eliminated clogging events to happen and provides a design guideline for on-chip solid particle synthesis. We believe our platform can be furtherer extended to synthesize materials with higher complexity such as fibers in a high throughput manner. These platforms can be applied to the synthesis of a wide range of photopolymers with a meaningful quantity for fields in tissue engineering or drug delivery. Further description regarding droplet generators can be found in, e.g., S. Yadavali, D. Lee, and D. Issadore, Sci Rep 9, 12213 (2019), which reference is incorporated herein in its entirety for any and all purposes.

### Experimental

### Silicon Chip Fabrication

A process of four-layer lithography combined with ion etching is performed to fabricate the 3-D structure of the silicon chip. Starting from the first layer, 12 μm S-1805 positive photoresist is spray-coated on a double-side polished wafer. After soft baking of 2 mins at 90° C., the wafer is exposed with UV to pattern the delivery channels. The wafer is then rehydrated in air for 12 hours, followed by a development in MF-319 for 2 mins, and a hard bake at 110ºC for 10 mins. The wafer is etched in DRIE, and cleaned in acetone, IPA, DI water for 5 mins, and Nanostrip for an hour subsequently.

For the second layer, a 6 μm SiO2 is deposited on the etched layer using PECVD. The SiO2 is then patterned using 8 μm photoresist following the procedure for the first layer. The wafer is flipped for the third layer. 8 μm of photoresist is spray-coated on the wafer and then soft baked for 4 mins at 90° C. Then it is exposed to the UV for the VIAS pattern, followed by a development in MF-319 for 2 mins, and a hard bake at 110° C. for 10 mins. The VIAS are then etched in DRIE so that they are through the silicon wafer. Then the wafer is cleaned using the same procedure as mentioned above. For the last layer, the wafer is first coated with a layer of HMDS (hexamethyldisilane) using a YES oven to enhance the adhesion between wafer and resist.

After coating 4 μm of photoresist, the wafer is soft baked in an oven at 110° C. for 7 mins. Then the wafer is exposed with UV for underpass and droplet maker patterns. The rest of the process is the same as the previous layers. Eventually, the etched wafer is submerged in HF to dissolve the oxide layer and Piranha solution to dissolve other organic residues. After washing the wafer thoroughly with DI water and dried using spin rinse dryer. The wafer is anodically bonded with two borosilicate glass wafers on both sides. The wafer is then bonded with stainless steel connectors using Epoxy glue (Gorilla) and ready to be in use for experiments.

### PEGDA Microgel Synthesis

The microgel precursor solution consisted 10% vol/vol of poly-ethylene glycol diacrylate with Molecular weight of 575 (Sigma Aldrich) and 0.5 wt % of lithium-benzophenotriphosphate (LAP, Colorado polymer) were dissolved in Millipore de-ionized water and mixed with a magnetic stirrer for 30 minutes at room temperature. The pre-polymer solution was prepared and transferred into a UV-opaque bottle to prevent unwanted crosslinking and later used as the dispersed phase in the experiment. The continuous phase consisted of perfluorinated oil HFE-7500 (3M) with 2 wt % of Krytox-FSH157 (Dupont) to stabilize the emulsion. Continuous phase of 3 L and dispersed phase of 1 L were prepared and used for each experiment.

During the experiment, the silicon chip was placed under a chromium photomask (Telic company) to pattern the exposure regions. A high-power LED UV-flood source was used for on-chip curing (SkyRay 800, Uvitron). The generated microgels were collected HFE-7500 containing 10 vol % 1H, 1H,2H,2H-Perfluoro-1-octanol (Millipore Sigma) to destabilize the surfactants for further cleaning.

The collected gels are divided into small batches in 50 ml conical tubes and cleaned with a series of washing steps. Excess oils are removed with syringe, followed by addition of hexane (Millipore Sigma) to dissolve the remaining oil. After centrifugation at 5000 rpm for 3 mins, supernatant is removed. The same process is performed with a 50/50 mixture of IPA/water to remove the remaining hexane and then with DI water to remove the remaining IPA. Each step is repeated for three times before the next step to ensure complete removal of the organic solvents.

### High Throughput Station Setup

A pressure-driven system is used to operate the high throughput microfluidic device for microgel generation. Two 1-gallon stainless steel pressure vessels (alloy products) are pressurized by two nitrogen tanks to deliver the fluids into the microfluidic device. One vessel is for storing the continuous phase and the other vessel for the dispersed phase. The fluidic device is connected to the pressure vessels by PTFE tubing (McMaster Carr 52245K609), and inline filters (McMaster Carr: 9816K72) are used to filter debris in both phases. The flow rates of both phases are controlled by adjusting the pressure valves of the nitrogen tanks and measured using two inline flow meters (McMaster Carr: 5084K23). The flow rate of the dispersed phase is kept at a constant rate of 1 L/hr while the flow rate of the continuous phase is varied from 2 to 4 L/hr.

### Capillary Micromechanics Testing

A capillary with 1 mm outer diameter (World Precision Engineering, model: 1B100-6) is pulled using a micropipette puller (Sutter Instrument, model P-1000) to prepare a tapered capillary with a tip diameter <30 μm. The capillary is then washed sequentially with acetone, IPA and water. Subsequently, 1% of BSA solution is flushed through the capillary to prevent adhesion of microgels to the wall, followed by a nitrogen purge. The dried capillary is connected to a water reservoir through polyethylene tubing (Scientific Commodities Inc: BB31695-PE/5). Cleaned microgel particles are loaded into the tubing and pushed toward the tapered tip of the capillary by adding more water into the water reservoir.

### Aspects

The following Aspects are illustrative only and do not limit the scope of the present disclosure or the appended claims.

Aspect 1. A microgel generator, comprising: a continuous phase fluid inlet for receiving a continuous phase fluid; a dispersed phase fluid inlet for receiving a dispersed phase fluid; a plurality of exposure lanes, the plurality of exposure lanes in fluid communication with the continuous phase inlet and the dispersed phase inlet; a plurality of flow focusing generators, a flow focusing generator defining a microdroplet outlet through which discrete portions of the dispersed phase fluid are exerted, an exposure lane being in fluid communication with the microdroplet outlet of a flow focusing generator associated with that exposure lane; and a radiation source, the radiation source configured to illuminate at least a portion of the exposure lanes so as to effect curing of polymer comprised in microdroplets disposed in the exposure lanes.

It should be understood that the foregoing features can all be disposed on a single microfluidic chip. In this way, the disclosed technology allows for efficient fabrication of devices, which devices can be constructed in a multiplexed way to include massive numbers of flow focusing generators and exposure lanes on a single microfluidic chip.

Aspect 2. The microgel generator of Aspect 1, further comprising a shield that at least partially blocks illumination of the radiation source, the shield being disposed to as to shield the plurality of flow focusing generators from illumination of the radiation source. A shield can be formed of metal (e.g., aluminum) or other material that is partially or even completely opaque to the radiation applied from the radiation source. Without being bound to any particular theory or embodiment, shielding the flow focusing generators (which form droplets of the dispersed phase fluid) from the radiation can prevent unwanted curing of polymer present in the flow focusing generators, which curing can clog or otherwise impair the flow focusing generators' operation.

Aspect 3. The microgel generator of Aspect 2, wherein the shield is disposed so as to shield at least a portion of the exposure lanes from illumination of the radiation source. Without being bound to any particular theory or embodiment, a portion of the exposure lanes that is immediately downstream from the flow focusing generators can be shielded. Such portion can represent from about 0.1% to about 75% of the length of an exposure lane, e.g., from about 0.1% to about 75%, from about 0.5 to about 50%, from about 1% to about 40%, from about 5% to about 35%, or even from about 10% to about 25% of the length of an exposure lane.

Aspect 4. The microgel generator of any one of Aspects 1-3, further comprising a collection channel in fluid communication with an exposure lane. A collection channel can define a width that is larger than the width of the microdroplet outlet of the flow focusing generator that is associated with the exposure lane that is in communication with the collection channel, e.g., from about 5 to about 100 times the width of the microdroplet outlet, e.g., from about 5 to about 100 times the width of the microdroplet outlet, from about 10 to about 80 times the width of the microdroplet outlet, from about 20 to about 60 times the width of the microdroplet outlet, or from about 30 to about 50 times the width of the microdroplet outlet.

Aspect 5. The microgel generator of any one of Aspects 1-4, wherein the microdroplet outlet of a flow focusing generator defines a cross-sectional dimension that is about equal to a cross-sectional dimension of the exposure lane associated with the flow focusing generator.

Aspect 6. The microgel generator of any one of Aspects 1-4, wherein the microdroplet outlet of a flow focusing generator defines a cross-sectional dimension that is larger than a cross-sectional dimension of the exposure lane associated with the flow focusing generator.

Aspect 7. The microgel generator of any one of Aspects 1-4, wherein the microdroplet outlet of a flow focusing generator defines a cross-sectional dimension that is smaller than a cross-sectional dimension of the exposure lane associated with the flow focusing generator.

Aspect 8. The microgel generator of any one of Aspects 1-7, wherein the radiation source is a source of ultraviolet radiation.

Aspect 9. The microgel generator of any one of Aspects 1-8, comprising from about 500 to about 4000 flow focusing generators on a microfluidic chip. The number of flow focusing generators can vary depending on the size of the microfluidic chip on which the flow focusing generators are disposed.

Aspect 10. A method, comprising operating a microgel generator according to any one of Aspects 1-9 so as to form microgel particles. The microgel particles can be hydrogels in nature.

Aspect 11. A method, comprising: flowing a dispersed phase fluid comprising a polymerizable material and a continuous phase fluid such so as to give rise to discrete droplets of the dispersed phase fluid disposed within the continuous phase fluid, the discrete droplets disposed in a section of a microfluidic chip; and curing the discrete droplets while the discrete droplet is within the microfluidic chip so as to form microgel particles, the curing being accomplished by radiation exposure. A polymerizable material can be a biocompatible polymer, e.g., PEG, PLGA, and the like.

Aspect 12. The method of Aspect 11, wherein the flowing is performed in a continuous manner.

Aspect 13. The method of any one of Aspects 11-12, wherein the microgel particles are characterized as hydrogels.

Aspect 14. The method of any one of Aspects 11-13, further comprising collecting the microgel particles.

Aspect 15. The method of any one of Aspects 11-14, wherein the microgel particles are spherical.

Aspect 16. The method of any one of Aspects 11-14, wherein the microgel particles are non-spherical. As examples, microgel particles can define a non 1:1 aspect ratio and can have the form of, e.g., rods, or rafts. A microgel particle made according to the present disclosure can define an aspect ratio of from about 1:1 to 1:2, 1:1 to 1:5, 1:1 to 1:10, 1:1 to 1:15, or even 1:1 to 1:20.

Aspect 17. The method of any one of Aspects 11-16, wherein the method is performed so as to form, in parallel, the discrete droplets of the dispersed phase fluid disposed within the continuous phase fluid. Without being bound to any particular theory or embodiment, the disclosed methods can be performed using parallel lanes, e.g., as shown in FIG. 1B.

Aspect 18. The method of any one of Aspects 11-17, wherein the method is performed so as to form, in parallel, the microgel particles.

Aspect 19. The method of any one of Aspects 11-18, wherein the microgel particles define a cross-sectional dimension in the range of from about 5 μm to about 100 μm, e.g., from about 5 to about 100 μm, from about 10 to about 95 μm, from about 15 to about 90 μm, from about 20 to about 85 μm, from about 25 to about 80 μm, from about 30 to about 75 μm, from about 35 to about 70 μm, from about 40 to about 65 μm, from about 45 to about 60 μm, from about 50 to about 55 μm.

Aspect 20. The method of any one of Aspects 11-18, wherein the microgel particles have a coefficient of variation (CV) of less than about 5%. The microgel particles can have a CV of less than 5%, less than 4.5%, less than 4%, less than 3.5% or even less than 3%.

### REFERENCES

The following references are included herein for the reader's convenience; the inclusion of a reference in the listing should not be considered a statement that the reference is material in any way to the patentability of the disclosed technology.
[1] D. R. Griffin, W. M. Weaver, P. O. Scumpia, D. Di Carlo, T. Segura, Nat Mater 2015, 14, 737.
[2] A. C. Daly, L. Riley, T. Segura, J. A. Burdick, Nat Rev Mater 2019, DOI 10.1038/s41578-019-0148-6.
[3] W. Li, L. Zhang, X. Ge, B. Xu, W. Zhang, L. Qu, C.-H. Choi, J. Xu, A. Zhang, H. Lee, D. A. Weitz, Chem. Soc. Rev. 2018, 47, 5646.
[4] M. E. Wechsler, R. E. Stephenson, A. C. Murphy, H. F. Oldenkamp, A. Singh, N. A. Peppas, Biomed Microdevices 2019, 21, 31.
[5] D. M. Headen, J. R. García, A. J. García, Microsyst Nanoeng 2018, 4, 17076.
[6] J. K. Oh, R. Drumright, D. J. Siegwart, K. Matyjaszewski, Progress in Polymer Science 2008, 33, 448.
[7] Y. Du, E. Lo, S. Ali, A. Khademhosseini, Proceedings of the National Academy of Sciences 2008, 105, 9522.
[8] W. Jiang, M. Li, Z. Chen, K. W. Leong, Lab Chip 2016, 16, 4482.
[9] P. Agarwal, S. Zhao, P. Bielecki, W. Rao, J. K. Choi, Y. Zhao, J. Yu, W. Zhang, X. He, Lab Chip 2013, 13, 4525.
[10] H. Huang, Y. Yu, Y. Hu, X. He, O. Berk Usta, M. L. Yarmush, Lab Chip 2017, 17, 1913.
[11] A. J. Engler, S. Sen, H. L. Sweeney, D. E. Discher, Cell 2006, 126, 677.
[12] H. K. Heris, J. Daoud, S. Sheibani, H. Vali, M. Tabrizian, L. Mongeau, Adv Healthc Mater 2016, 5, 255.
[13] N. F. Truong, E. Kurt, N. Tahmizyan, S. C. Lesher-Pérez, M. Chen, N. J. Darling, W. Xi, T. Segura, Acta Biomater 2019, 94, 160.
[14] C. Wischke, International Journal of Pharmaceutics 2020, 584, 119401.
[15] P. Zhu, L. Wang, Lab Chip 2016, 17, 34.
[16] D. Dendukuri, D. C. Pregibon, J. Collins, T. A. Hatton, P. S. Doyle, Nature Materials 2006, 5, 365.
[17] S. Guo, G. Kang, D. T. Phan, M. N. Hsu, Y. C. Por, C. H. Chen, Sci Rep 2018, 8, 2245.
[18] Z. Nie, W. Li, M. Seo, S. Xu, E. Kumacheva, J. Am. Chem. Soc. 2006, 128, 9408.
[19] J. M. de Rutte, J. Koh, D. Di Carlo, Adv. Funct. Mater. 2019, 29, 1900071.
[20] S. Utech, R. Prodanovic, A. S. Mao, R. Ostafe, D. J. Mooney, D. A. Weitz, Advanced Healthcare Materials 2015, 4, 1628.
[21] S. Marre, K. F. Jensen, Chem. Soc. Rev. 2010, 39, 1183.
[22] S. Yadavali, H.-H. Jeong, D. Lee, D. Issadore, Nat Commun 2018, 9, 1222.
[23] S. Yadavali, D. Lee, D. Issadore, Sci Rep 2019, 9, 12213.
[24] H.-H. Jeong, V. R. Yelleswarapu, S. Yadavali, D. Issadore, D. Lee, Lab Chip 2015, 15, 4387.
[25] Y. Lan, J. Wu, S. H. Han, S. Yadavali, D. Issadore, K. J. Stebe, D. Lee, ACS Sustainable Chem. Eng. 2020, DOI 10.1021/acssuschemeng.0c04929.
[26] W. Li, J. Greener, D. Voicu, E. Kumacheva, Lab Chip 2009, 9, 2715.
[27] M. B. Romanowsky, A. R. Abate, A. Rotem, C. Holtze, D. A. Weitz, Lab Chip 2012, 12, 802.
[28] S. Seiffert, J. Dubbert, W. Richtering, D. A. Weitz, Lab Chip 2011, 11, 966.
[29] O. Schmidt, M. Bassler, P. Kiesel, N. M. Johnson, G. H. Döhler, Appl. Phys. Lett. 2006, 88, 151109.
[30] K. Krutkramelis, B. Xia, J. Oakey, Lab Chip 2016, 16, 1457.
[31] C.-H. Choi, J.-H. Jung, T.-S. Hwang, C.-S. Lee, Macromol. Res. 2009, 17, 163.
[32] N. A. Filatov, D. V. Nozdriukhin, A. S. Bukatin, J. Phys.: Conf. Ser. 2017, 917, 042024.
[33] T. Kong, L. Wang, H. M. Wyss, H. C. Shum, Soft Matter 2014, 10, 3271.
[34] H. M. Wyss, T. Franke, E. Mele, D. A. Weitz, Soft Matter 2010, 6, 4550.
[35] J. A. Bonham, M. A. Faers, J. S. van Duijneveldt, Soft Matter 2014, 10, 9384.
[36] M. Urich, A. R. Denton, Soft Matter 2016, 12, 9086.
[37] D. Dendukuri, K. Tsoi, T. A. Hatton, P. S. Doyle, Langmuir 2005, 21, 2113.

1. A microgel generator, comprising:
a continuous phase fluid inlet for receiving a continuous phase fluid;
a dispersed phase fluid inlet for receiving a dispersed phase fluid;
a plurality of exposure lanes,
the plurality of exposure lanes in fluid communication with the continuous phase inlet and the dispersed phase inlet:
a plurality of flow focusing generators,
a flow focusing generator defining a microdroplet outlet through which discrete portions of the dispersed phase fluid are exerted,
an exposure lane being in fluid communication with the microdroplet outlet of a flow focusing generator associated with that exposure lane; and
a radiation source,
the radiation source configured to illuminate at least a portion of the exposure lanes so as to effect curing of polymer comprised in microdroplets disposed in the exposure lanes.

2. The microgel generator of claim 1, further comprising a shield that at least partially blocks illumination of the radiation source, the shield being disposed to as to shield the plurality of flow focusing generators from illumination of the radiation source.

3. The microgel generator of claim 2, wherein the shield is disposed so as to shield at least a portion of the exposure lanes from illumination of the radiation source.

4. The microgel generator of claim 1, further comprising a collection channel in fluid communication with an exposure lane.

5. The microgel generator of claim 1, wherein the microdroplet outlet of a flow focusing generator defines a cross-sectional dimension that is about equal to a cross-sectional dimension of the exposure lane associated with the flow focusing generator.

6. The microgel generator of claim 1, wherein the microdroplet outlet of a flow focusing generator defines a cross-sectional dimension that is larger than a cross-sectional dimension of the exposure lane associated with the flow focusing generator.

7. The microgel generator of claim 1, wherein the microdroplet outlet of a flow focusing generator defines a cross-sectional dimension that is smaller than a cross-sectional dimension of the exposure lane associated with the flow focusing generator.

8. The microgel generator of claim 1, wherein the radiation source is a source of ultraviolet radiation.

9. The microgel generator of claim 1, comprising from about 500 to about 4000 flow focusing generators on a microfluidic chip.

10. A method, comprising operating a microgel generator according to claim 1 so as to form microgel particles.

11. A method, comprising:
flowing a dispersed phase fluid comprising a polymerizable material and a continuous phase fluid such so as to give rise to discrete droplets of the dispersed phase fluid disposed within the continuous phase fluid,
the discrete droplets disposed in a section of a microfluidic chip; and
curing the discrete droplets while the discrete droplet is within the microfluidic chip so as to form microgel particles,
the curing being accomplished by radiation exposure.

12. The method of claim 11, wherein the flowing is performed in a continuous manner.

13. The method of claim 11, wherein the microgel particles are characterized as hydrogels.

14. The method of claim 11, further comprising collecting the microgel particles.

15. The method of claim 11, wherein the microgel particles are spherical.

16. The method of claim 11, wherein the microgel particles are non-spherical.

17. The method of claim 11, wherein the method is performed so as to form, in parallel, the discrete droplets of the dispersed phase fluid disposed within the continuous phase fluid.

18. The method of claim 11, wherein the method is performed so as to form, in parallel, the microgel particles.

19. The method of claim 11, wherein the microgel particles define a cross-sectional dimension in the range of from about 5 μm to about 100 μm.

20. The method of claim 11, wherein the microgel particles have a coefficient of variation (CV) of less than about 5%.
